(19) United States
(12) Patent Application Publication
(10) Pub. No.: US 2026/0349105 A1
(43) Pub. Date: Nov. 5, 2026

(54) METHOD AND DEVICES FOR DETERMINING A RESPECTIVE DISTANCE VALUE, WHICH REPRESENTS THE DISTANCE BETWEEN A VEHICLE TRANSCEIVER ON A VEHICLE AND A MOBILE DEVICE TRANSCEIVER, BY EXCHANGING MESSAGES

(71) Applicant: AUMOVIO Germany GmbH, Frankfurt am Main (DE)

(72) Inventor: Stefan Hammes, Regensburg (DE)

(73) Assignee: AUMOVIO Germany GmbH, Frankfurt am Main (DE)

(21) Appl. No.: 19/485,745

(22) PCT Filed: May 14, 2024
(86) PCT No.: PCT/DE2024/200040

§ 371 Date: Nov. 19, 2025

(30) Foreign Application Priority Data
May 24, 2023 (DE) 10 2023 204 842.6

(51) Int. Cl. G01S 13/76; H04W 64/00

(52) U.S. Cl. CPC G01S 13/765; H04W 64/003

(57) ABSTRACT

A method and a device designed to determine at least one current distance value, which represents the distance between a vehicle transceiver on a vehicle and a mobile device transceiver, by exchanging messages. The device is designed to determine a current distance value using fewer than all of the vehicle transceivers if an earlier distance value could already be determined previously.

### CROSS REFERENCE TO RELATED APPLICATION

This application is the U.S. National Phase Application of PCT International Application No. PCT/DE2024/200040, filed May 14, 2024, which claims priority to German Patent Application No. 10 2023 204 842.6, filed May 24, 2023, the contents of such applications being incorporated by reference herein.

### FIELD OF THE INVENTION

Method and devices for determining a respective distance value, which represents the distance between a vehicle transceiver on a vehicle and a mobile device transceiver, by exchanging messages.

The present application relates to methods and devices for determining a respective distance value, which represents the distance between a vehicle transceiver on a vehicle and a mobile device transceiver, by exchanging messages.

### BACKGROUND OF THE INVENTION

The determination of a distance between a vehicle transceiver and a mobile device transceiver (e.g., smartphone, SmartWatch, ID transducer (e.g. vehicle key, keyfob)) by means of UWB ToF (Time of Flight) can be organized, for example, in what is known as a “UWB ranging session”, which can define, inter alia, the temporal behavior (ranging cycle, repetition rate, etc.) when exchanging messages for distance determination.

The localization of mobile device transceivers such as in particular smart devices (SO) by ultra-wide band (UWB) is based, for example, on distance measurement using the so-called Time of Flight (ToF) measurement method with, for example, a so-called “ranging”. Such a distance measurement can be used, for example, only for a limited time, for example for 30 s. After this time has elapsed, the localization is paused, that is to say at least temporarily/momentarily terminated.

If the localization is then to be resumed, for example after an action by the vehicle user (pull on the door handle, actuation of the start pedal or start button or the like), it can take several seconds until the measurement is started again and until the mobile device transceiver has been localized.

According to the currently used standard (CCC TS-101, R3 V1.1.0), incorporated herein by reference, the establishment of what is known as the ranging session is shortened by virtue of certain parameters that are necessary for the establishment of the ranging session not being transmitted or not being transmitted completely. Furthermore, this specification describes a way of determining the joint time reference of SO and vehicle before the start of the ranging session by using another communication channel (Blue Tooth Low Energy, BLE).

### SUMMARY OF THE INVENTION

An aspect of the invention is to optimize a determination of a distance value (representing a distance between at least one motor vehicle transceiver on the motor vehicle and a mobile device transceiver outside the motor vehicle). This is achieved by the subject matters of the independent claims. Some particularly advantageous embodiments of the invention are specified in the dependent claims and the description. Embodiments of the invention can, as alternatives to existing solutions, make it possible to quickly determine a distance and/or a time of flight between a vehicle and a (mobile device) transceiver.

With respect to some embodiments of the invention according to the dependent claims:

According to one embodiment of the invention, a present distance value is determined by one and/or fewer than all of the vehicle transceivers.

According to a further embodiment of the invention, a current distance value is determined by means of a TimeOfFlight determination and/or a ranging.

According to a further embodiment of the invention, a current distance value is determined in response to a detected action of a user of the vehicle, in particular after it is detected that the vehicle engine is started or after a pull is detected on the door handle or an actuation of the start pedal or start button of the vehicle is detected.

According to another embodiment of the invention, a current distance value outside the vehicle is determined multiple times each time with a different one of the vehicle transceivers in and/or outside the vehicle.

According to another embodiment of the invention, a mobile device transceiver is a cellular mobile radio terminal and/or a smartphone and/or a vehicle key.

Further features and advantages of some advantageous embodiments of the invention will be apparent from the following description of some exemplary embodiments of the invention based on the drawing.

### BRIEF DESCRIPTION OF THE DRAWINGS

For simplification, to illustrate some possible embodiments of the invention schematically, in particular:

FIG. 1 shows an embodiment according to the invention of a transmission of messages between a mobile device transceiver and vehicle transceivers for distance determination,

FIG. 2 shows an embodiment according to the invention of a distance determination based on the exchange of, for example, three messages and here possibly also of transmission/reception times in a simple ranging session,

FIGS. 3-6 each show an embodiment according to the invention of a transmission of messages between a mobile device transceiver and one or more vehicle transceivers for distance determination.

### DETAILED DESCRIPTION OF EXEMPLARY EMBODIMENTS

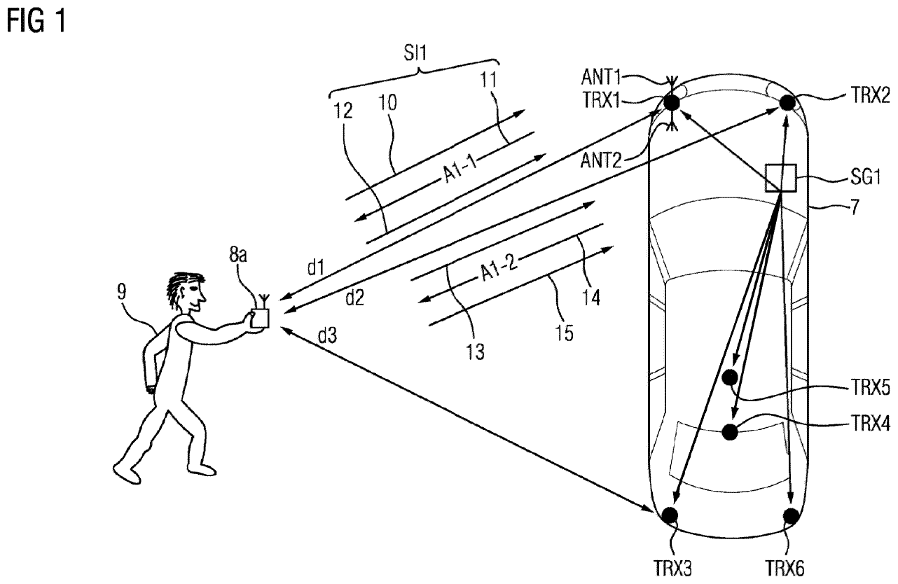

FIG. 1 shows, by way of example, how messages 10, 11, 12, 13, 14, 15, etc. (using, for example, UWB/UltraWideBand) are exchanged between one (TRX1) of multiple vehicle transceivers (TRX1, TRX2, TRX3, TRX4, TRX5, TRX6) of a (motor) vehicle 7 and a mobile device transceiver 8a (for example, mobile phone, smartphone, smartwatch, watch, ID transducer, motor vehicle key, key fob, etc.) belonging to a user 9 in order to obtain at least one distance value d1 representing a distance d1 from the mobile device transceiver 8a to the vehicle transceiver TRX1 (e.g. distance d1 or message time of flight). (Accordingly, further (for example three) messages are exchanged, for example, possibly with a further transceiver TRX3, and also, if appropriate, accordingly respectively with further transceivers TRX4 and TRX5 and possibly also some further transceivers.)

Accordingly, it is possibly possible for messages 13, 14, 15 to be exchanged (e.g., UWB/UltraWideband) additionally between a further one (TRX2) of multiple vehicle transceivers (also referred to as anchors) of the (motor) vehicle 7 and the mobile device transceiver 8a, in order to determine a distance value d2 (e.g., distance d2 or message time of flight) representing a distance d2 from the mobile device transceiver 8a to the vehicle transceiver TRX2.

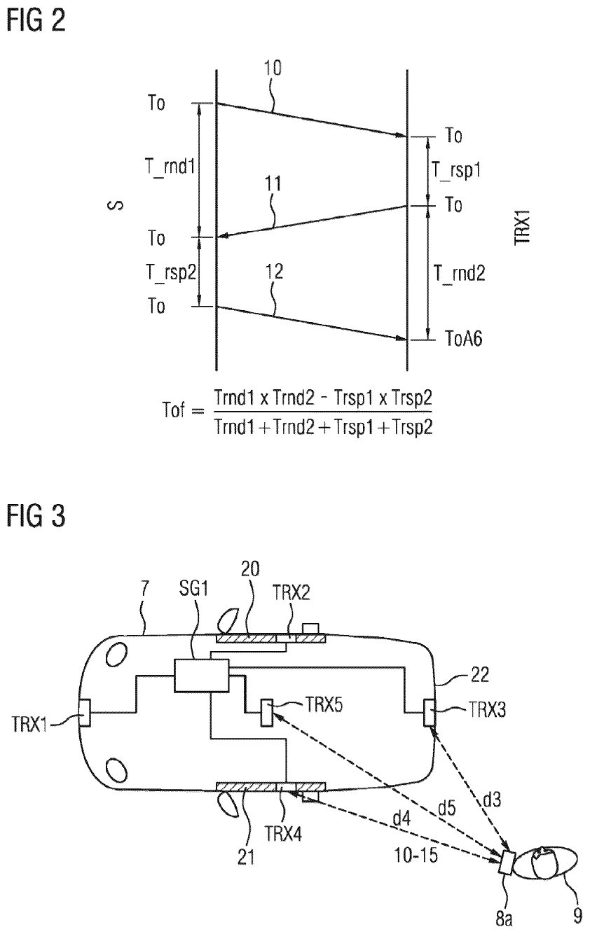

From one or more distance values d1, d2, . . . the position of the mobile device transceiver 8a relative to at least one vehicle transceiver TRX1 and/or to/in the vehicle 7 (or to the vehicle center) can be determined (for example by triangulation), for example by a controller SG1 which controller SG1 can receive, for example, information relating to signal propagation delays (such as the ToF or some/all of the T_rnd1, T_rsp1, T_rnd2, T_rsp2. etc. in FIG. 2) or distance values d1, d2, . . . of vehicle transceivers TRX1, TRX2, TRX3, TRX4, . . . .

Position determination can comprise, for example, determining whether the mobile device transceiver 8a is located in the exterior space outside the vehicle 7 or in the interior inside the vehicle 7. For example, in order to allow vehicle starting only when the mobile device transceiver 8a is in the interior of the vehicle 7.

Opening (or closing) at least one door or starting of the vehicle 7 can take place, for example, if one or more distances d1, d2, etc. fall below (or exceeded for closing) a value and/or distances decrease over time and/or further criteria are possibly satisfied.

Communications with different vehicle transceivers and/or the different mobile device transceivers may be distinguishable for example on the basis of IDs or headers which differ depending on the transceiver and are contained in messages, and/or on the basis of specified time slots or in some other way.

Determination of a distance between vehicle transceivers on the part of a vehicle and a mobile device transceiver by means of what is known as a TimeOfFlight (ToF) method is described, for example, in DE 10 2021 207 725.0 (202104661) or DE102019211152, which are incorporated in the disclosure of this application by reference.

As shown in FIG. 2, it is possible for example to calculate (for example in a vehicle transceiver and/or also in a mobile device transceiver or in a controller SG1) times of flight or time of flight relationships ToF and possibly therewith (d1=c*ToF etc.) distances d1, d2 etc. and/or on the basis of the times at which the individual messages 10, 11, 12 etc. (corresponding other messages) were sent and received (or on the basis of periods of time between transmission times and reception times such as T_rnd1, T_rsp1, T_rnd2, Trsp2), in particular when (some/reciprocal) transmission and/or reception times are transmitted between the mobile device transceiver 8a and vehicle transceiver TRX1.

For example, propagation times or distances d1 etc. can be calculated using the formula specified in FIG. 2:

ToF=(T_rnd1*T_rnd2−T_rsp1*T_rsp2)/(T_rnd1+T_rnd2+T_rsp1+T_rsp2)

The distance d1 is, for example, d1=c*ToF (c=speed of light in air) This distance calculation can be particularly secure with respect to illegal attempts to open doors. Such a method is also called “ranging” or “TimeOfFlight ranging”.

The messages 10, 11, 12 transferred (between a mobile device transceiver 8a and a vehicle transceiver TRX1), for example, in FIG. 2, which messages make it possible to calculate a distance value d1, are denoted for example as a session having a session index SI or SI1.

In FIGS. 1, 2, for example, the messages 10, 11, 12 (first mobile device transceiver 8a) form a session having the session index SI1.

The determination of a distance between a vehicle transceiver and a mobile device transceiver (e.g. smartphone, SmartWatch, ID transducer (e.g. vehicle key, keyfob)) by means of UWB ToF (Time of Flight) can be organized, for example, in a so called ranging session or “UWB ranging session”, which can define, inter alia, the temporal behavior (ranging cycle, repetition rate, etc.) when exchanging messages for distance determination.

FIG. 3 shows, as an examplary embodiment of the invention, how messages 10, 11, 12, etc. (using, for example, UWB/UltraWideBand) are exchanged between one (TRX1) of possible multiple vehicle transceivers (TRX1, TRX2, TRX3, TRX4, TRX5) of a (motor) vehicle 7 and a mobile device transceiver 8a (for example, mobile phone, smartphone, smartwatch, watch, ID transducer, motor vehicle key, key fob, etc.) belonging to a user 9 in order to obtain at least one distance value d3 representing a distance d3 from the mobile device transceiver 8a to the vehicle transceiver TRX3 (e.g. distance d3 or message time of flight ToF).

The localization of smart devices (also called SO for short) 8a per e.g. ultra wide band (UWB) is based, for example, on distance measurement by means of the so-called time of flight (ToF) measurement method (“ranging”).

Since this measurement requires energy, it can possibly also be used e.g. only for a limited time in a correspondingly equipped vehicle 7, e.g. for 30 s. After this time has elapsed, the distance determination or localization can be paused, that is to say at least temporarily/temporarily terminated. If the distance determination or localization is now to be resumed, triggered e.g. by an action by the vehicle user (pull on the door handle of a door 20, 21, 22, actuation of the start pedal or start button or the like), it may take some time until the measurement is started again and a location (by d1, d2, etc.) of the mobile device transceiver (SO) 8a has been effected.

According to the currently used standard (CCC TS-101, R3 V1.1.0), the establishment of the so called ranging session is shortened by virtue of certain parameters that are necessary for the establishment of the ranging session not being transmitted or not being transmitted completely. This specification furthermore describes a way of stipulating the common time relationship between the mobile device transceiver (SO) 9 and the vehicle 7 by another communication channel (Blue Tooth Low Energy, BLE) before the start of a current ranging session.

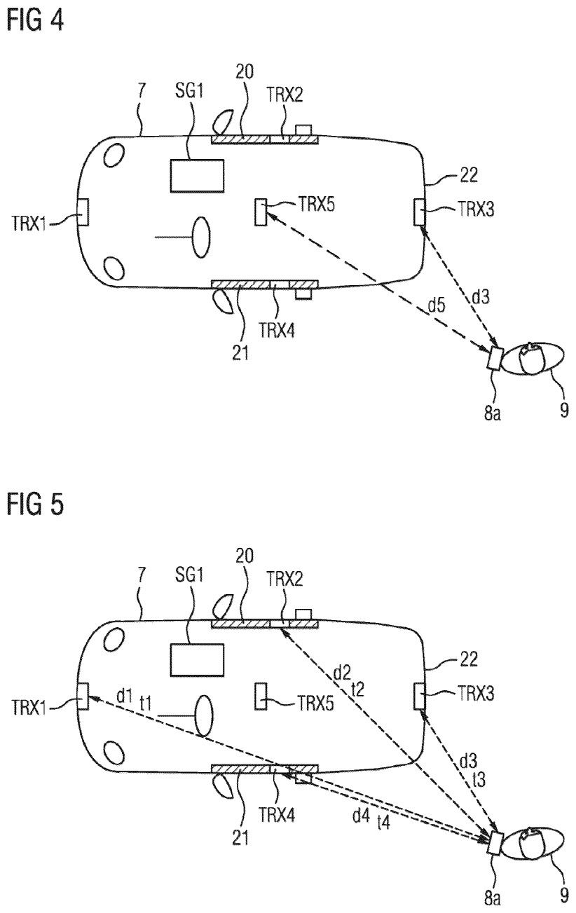

By way of example, the locating of the mobile device transceiver (SO) 8a was successful at least once beforehand, that is to say at least one (earlier) distance d1 (and/or d2, d3, d4, d5, etc.) could be determined at least once, and/or the mobile device transceiver 8a could be uniquely assigned to the interior (space in the vehicle 7) and/or, as in FIG. 4, to the exterior space (region outside the vehicle 7).

It is then possible, for example, as in FIG. 5, for at least one current distance value d1 etc. (e.g. a time of flight or distance) between a respective vehicle transceiver TRX1-TRX4, for example in the exterior (outside the vehicle 7), and a mobile device transceiver 8a to be determined, for example, after a detected action of a vehicle user 9.

It is also possible, for example, to sequentially and successively determine for each distance value determination, only the distance (of the mobile device transceiver 8a) from another of the vehicle transceivers TRX1-TRX4 in the exterior (or TRX1-TRX5), or also, for example, the distance from respective two other (other than the last) of the vehicle transceivers TRX1-TRX4 in the exterior space.

Furthermore, a controller (for example SG1) can monitor the state of the vehicle entrances (doors 20, 21, trunk 22, etc.) 20, 21, 22 of the vehicle 7.

In the case of closed vehicle entrances 20, 21, 22 and mobile device transceiver (SO) 9 detected in a sufficiently reliable manner in the exterior, e.g. only the current distance d3 from, for example, (at least) one of the transceivers (“anchors”) TRX3 assigned to the exterior or located in the exterior is determined, as in FIG. 4, and possibly e.g. a further distance d5 from a further transceiver TRX5 located in the exterior or in the interior.

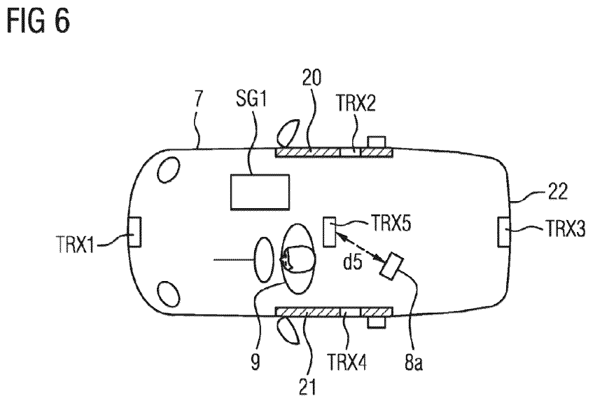

For example, in the case of closed vehicle entrances 20, 21, 22 and a mobile device transceiver 8a which has been detected in the interior with enough reliability, for functions such as vehicle access or vehicle starting (e.g. release of the immobilizer) for example only the current distance d5 from one of the “anchors” TRX5 (of the UWB measuring system of the vehicle 7) arranged in the interior is then determined, for example, as in FIG. 6. It is thus possible to determine e.g. whether the mobile device transceiver 8a is still in the interior of the vehicle 7. Alternatively or additionally, it is also possible to determine a current distance d3 from, for example, (at least) one of the transceivers (“anchors”) TRX3 assigned to the exterior or located in the exterior.

Instead of complete localization, only a distance measurement of distance values (d1, d2, d3), for example, is carried out using one or a few (fewer than all) anchors in the interior space or in the exterior space or in the interior space and in the exterior.

This means that the ranging session can be maintained over a longer period of time or permanently or e.g. until the vehicle 7 departs etc., without the same energy being required as in the case of complete localization.

As long as the vehicle entrances 20-22 remain closed, the system assumes e.g. that the assignment of the mobile device transceiver (SO) 9 to the exterior or interior, which assignment was determined during the previous localization (position determination by triangulation etc. with earlier distance values), is still valid, that is to say e.g. that the mobile device transceiver (SO) 9 continues to be located or situated in the exterior or interior. As a result, a reaction time of the system SG1 relative to an action (for example engine start, accelerator pedal etc.) of the vehicle user 9 can be shortened.

Furthermore, it would also be conceivable—but not generally recommended for reasons of theft protection—to stop the distance measurement completely and to rely only on the fact that the connection of the mobile device transceiver (SO) 8a to the vehicle 7 by BLE (Bluetooth, Bluetooth Low Energy) represents a sufficient criterion for the mobile device transceiver (SO) 8a to be still located in the previously determined zone (exterior or interior).

Since the distance measurement using only a single anchor in the exterior space could also be only suboptimal under certain circumstances, the distance measurement in the exterior can advantageously be distributed in turn or alternately to vehicle transceivers TRX1-TRX4 (anchor) assigned to the exterior.

1. A device designed to determine at least one current distance value representing a distance between a mobile device transceiver and a vehicle transceiver on a vehicle by exchanging messages,
wherein the device is designed to determine a current distance value using fewer than all of the vehicle transceivers, if an earlier distance value could already be determined previously with vehicle transceivers.

2. The device according to claim 1, wherein the device is designed to determine a current distance value using only one of the vehicle transceivers if an earlier distance value has already been determined beforehand using vehicle transceivers.

3. The device according to claim 1, wherein the device is designed to determine a current distance value using more than one but less than all of the vehicle transceivers if an earlier distance value has already been determined beforehand using vehicle transceivers.

4. The device according to claim 1, wherein the device is designed to determine a current distance value using less than all and/or less than the last used vehicle transceivers if an earlier distance value has already been determined beforehand using vehicle transceivers, and a determination of distance values was paused subsequently.

5. The device according to claim 1, wherein the device is designed so that the determination of a current distance value is carried out by a TimeOfFlight determination and/or a ranging.

6. The device according to claim 1, designed so that an association of the mobile device transceiver with the outside of the vehicle or with the interior inside the vehicle, which was established during a previous distance value determination and/or localization, is defined as still valid in the current distance value determination.

7. The device according claim 1, designed so that a current distance value and/or a determined position in the interior or exterior, determined using less than all and/or fewer than the last used vehicle transceivers taken into account only if the vehicle accesses of the vehicle are detected as closed,
otherwise, the current distance value is ignored and/or a current distance value is determined using multiple or all vehicle transceivers.

8. The device according to claim 1, designed so that the determination of a current distance value takes place in response to a detected action of a user of the vehicle after detection of starting of the vehicle engine or detected pull on the door handle or detected actuation of the start pedal or starting button of the vehicle.

9. The device according to claim 1, designed so that a multiple determination of a current distance value outside the vehicle takes place each time using a different vehicle transceiver or anchor located outside the vehicle.

10. The device according claim 1, designed for the mobile device transceiver to be a cellular mobile radio terminal and/or a smartphone and/or a vehicle key.

11. A method for determining at least one current distance value representing a distance between a vehicle transceiver of a vehicle and a mobile device transceiver by exchanging messages
with a device according to claim 1, wherein a current distance value is determined with fewer than all of the vehicle transceivers of the vehicle an earlier distance value could already be determined previously.
